(19) United States
(12) Patent Application Publication
(10) Pub. No.: US 2020/0268163 A1
(43) Pub. Date: Aug. 27, 2020

(54) MATTRESS WITH VALVE SYSTEM

(71) Applicant: Hill-Rom Services, Inc., Batesville, IN (US)

(72) Inventors: Jean-Bernard Duvert, Baud (FR); Nicolas Renaud, Charenton Le Pont (FR); Thierry Flocard, Montpellier (FR); Philippe Robert Pierre Kaikenger, Pluvigner (FR); Clementine Pirio, Vannes (FR); Mickael Audic, Locmiquelic (FR)

(21) Appl. No.: 16/783,248

(22) Filed: Feb. 6, 2020

(30) Foreign Application Priority Data
Feb. 22, 2019 (EP) 19158957.1

(51) Int. Cl. A47C 27/10; A61G 7/057; A47C 27/08

(52) U.S. Cl. CPC A47C 27/10; A47C 27/082; A47C 27/083; A61G 7/05776

(57) ABSTRACT

A mattress includes a support surface for supporting the body of a patient, a plurality of inflatable cells arranged below the support surface, and a valve system. The plurality of inflatable cells are arranged in layers including a first layer of inflatable cells arranged below the support surface and a second layer of inflatable cells arranged below the first layer, wherein each inflatable cell of the first layer is arranged above at least one cell of the second layer. The valve system includes a plurality of valves, each valve being fluidly connected to one of the inflatable cells of the first and second layers and each valve being controllable to enable inflation and deflation of the inflatable cell.

The present application claims priority, under 35 U.S.C. § 119(a), to European Application No. 19158957.1 which was filed Feb. 22, 2019 and which is hereby incorporated by reference herein.

### BACKGROUND

The present disclosure relates to a patient support apparatus, and in particular to a mattress for a hospital bed for supporting a patient in a prone position.

Prone positioning or prone therapy involves positioning a patient undergoing assisted ventilation in the prone position, with the dorsal side of the patient up and the ventral side of the patient down. Prone therapy is thought to improve oxygenation in patients and reduce the rate of ventilator-associated pneumonia (VAP), and so is often used for the treatment of acute respiratory distress syndrome (ARDS), acute lung failure, and acute lung injury (ALI).

Handling a patient in the prone position presents particular challenges for a caregiver, especially when a patient is ventilated. For example, a caregiver must take care to reduce the risk of pressure ulcers forming at sensitive areas of a patient in the prone position and a caregiver must ensure that any intubation or tracheotomy tubes of the patient remain free from constraints and obstructions.

It is known to provide a patient support apparatus or device in the form of mattresses for supporting a body of a patient. Mattresses of this type may comprise a structure made up, at least in part, of a plurality of inflatable elements or cells suitable for being inflated with a fluid, in particular for being inflated with air. The inflatable elements are generally in the form of substantially cylindrical sausage-shaped tubes that extend transversely or laterally relative to the longitudinal direction of the mattress and are disposed side-by-side in the longitudinal direction of the mattress. Other arrangements are also known, and depend on the specific requirements of the support apparatus.

It is known to arrange a plurality of support elements, such as gel pads, foam pads and pillows, over a mattress to support a patient in the prone position. These support elements, when appropriately arranged, provide some clearance from the mattress for vulnerable or sensitive areas of a patient in the prone position, such as the face, genitals and feet of the patient. However, providing clearance from a mattress for some areas of a patient also results in a reduced surface area of the patient being supported by the mattress, which increases the pressure experienced by the supported areas of the patient. In addition, arranging support elements on a mattress can be difficult for a caregiver. Currently, moving a ventilated patient from a supine position on a patient support apparatus to a prone position on the patient support apparatus may require at least three caregivers, and may require five or more caregivers, to safely move the patient and correctly position support elements beneath the patient.

Mattresses designed specifically to support patients positioned in the prone position have also been developed. Typically, these mattresses comprise a layer of inflatable cells, which are selectively deflatable to provide some clearance from the mattress for vulnerable areas of a patient in the prone position. The maximum depth of the clearance that may be provided by these known mattresses is the depth of an inflatable cell, which is, at most, the depth of the mattress, and is often less than half of the depth of the mattress. Where the clearance provided by the selected deflated cells alone is not sufficient, support elements, such as pads and pillows, may also be arranged on the mattress by a caregiver to provide additional clearance and support to areas of a patient.

Some mattresses comprise non-inflatable zones, such as a zone of foam, about the periphery of the mattress. For these mattresses, it is not possible to selectively deflate the zone of the mattress supporting the head of a patient. As a result, it may be necessary to position a ventilated patient in the prone position on such a mattress with the head of the patient arranged beyond the head end of the bed, so that the ventilation equipment is not constricted between the patient and the mattress. In this position, the head of the patient is clear of the mattress and is unsupported.

It would be desirable to provide a mattress that addresses the issues mentioned above. It would be desirable to provide a mattress that improves patient comfort while a patient is supported in the prone position. It would be desirable to provide a mattress that is able to support a significant proportion of the body of a patient in the prone position. It would be desirable to provide a mattress that provides a lower risk of formation of pressure ulcers for a patient supported in the prone position. It would be desirable to provide a mattress that is able to provide greater clearance from the mattress for selected areas of a patient supported on the mattress in the prone position.

### SUMMARY

According to a first aspect of the present disclosure, there is provided a mattress comprising: a support surface for supporting the body of a patient; a plurality of inflatable cells arranged below the support surface, and a valve system. The plurality of inflatable cells is arranged in layers and comprises a first layer of inflatable cells arranged below the support surface and a second layer of inflatable cells arranged below the first layer, wherein each inflatable cell of the first layer is arranged above at least one cell of the second layer. A valve system includes a plurality of valves, each valve being fluidly connected to an inflatable cell of the plurality of inflatable cells and each valve being controllable to enable inflation and deflation of the inflatable cell.

The valves of the valve system enable selective inflation and deflation of individual inflatable cells of the mattress. Providing the mattress of the first aspect with a valve system that enables individual inflatable cells to be selectively inflated and deflated may enable a caregiver to selectively inflate and deflate cells at particular positions of the mattress to provide clearance from the mattress to specific areas of the body of a patient supported on the mattress.

Furthermore, providing the mattress of the first aspect with two layers of selectively inflatable and deflatable cells, one layer arranged below the other layer, may enable the mattress to provide a caregiver with an improved degree of control over the profile of a mattress compared to mattresses having a single layer of selectively inflatable cells. Put in another way, the mattress of the present disclosure may enable a cell of the first layer and a cell of the second layer arranged below the cell of the first layer to be inflated simultaneously, deflated simultaneously, or one of the cells of the first layer and the second layer to be inflated and the other one of the cells of the first layer and the second layer to be deflated. This may enable the mattress to provide a greater change in depth of the mattress than a mattress having a single layer of selectively inflatable and deflatable cells.

A mattress according to the present disclosure may be configured to support a patient in the prone position in several ways, as described in more detail below.

The mattress may be divided into a plurality of zones. In some embodiments, the mattress is divided into a plurality of zones distributed or disposed along the length of the mattress. In other words, the zones may be arranged side-by-side in the longitudinal direction of the mattress. For example, the mattress may comprise a head zone at a head end of the mattress and a foot zone at a foot end of the mattress, opposite the head end.

The mattress may be divided into any suitable number of zones. For example, the mattress may be divided into at least two zones, at least three zones, at least four zones or at least five zones.

In some contemplated embodiments, the mattress is divided into at least four zones disposed along the length of the mattress. In these contemplated embodiments, the zones may include: a head zone at a head end of the mattress; a torso zone; a leg zone; and a foot zone at a foot end of the mattress, opposite the head end. The head zone may be arranged to support the head of a patient lying on the mattress. The torso zone may be arranged to support the torso of a patient lying on the mattress. The leg zone may be arranged to support the legs of a patient lying on the mattress. The foot zone may be arranged to support the feet of a patient lying on the mattress. Other zones of a mattress may include an abdominal zone, a genital zone, a thigh zone and a calf zone arranged to support corresponding parts of a patient lying on the mattress.

Where the mattress is divided into a plurality of zones, the first layer of inflatable cells may comprise at least at least one inflatable cell in each zone. Where the mattress is divided into a plurality of zones, the second layer of inflatable cells may comprise at least at least one inflatable cell in each zone. For example, where the mattress is divided into four zones, the second layer of inflatable cells may comprise four inflatable cells, each of the four inflatable cells being arranged in a different zone of the mattress.

In some embodiments, all adjacent cells in a zone of a layer are held together. In some embodiments, all adjacent cells of adjacent zones of a layer are held together. Optionally, holding together adjacent cells of adjacent zones of a layer may inhibit relative movement between the cells of adjacent zones, which may help the layer to maintain a particular geometric shape. In particular, adjacent cells of adjacent zones of the first layer may be held together. Further optionally holding together adjacent cells of adjacent zones of the first layer may inhibit or reduce movement of the cells of a zone of the first layer when a cell of the second layer in that zone is deflated.

In some embodiments, adjacent cells of adjacent zones of a layer may be free or unbonded. In other words, in some embodiments adjacent cells of adjacent zones of a layer are not held together. Optionally, in some cases, not holding together adjacent cells of adjacent zones of a layer may facilitate relative movement between the adjacent zones, which may enable one zone of a layer to maintain a particular geometric shape and an adjacent zone to adopt a different geometric shape. In particular, adjacent cells of adjacent zones of the second layer may be unbonded. Optionally, not bonding together adjacent cells of adjacent zones of the second layer may enable zones of the second layer to maintain their geometric shape when cells of adjacent zones of the second layer are inflated and deflated.

In embodiments in which the mattress is divided into zones, each inflatable cell of a layer in a particular zone may be fluidly connected to a valve of the valve system.

In some embodiments, only a portion of the mattress is configured to be adapted to support a patient in the prone position. For example, a torso zone and a leg zone of a mattress may be configured for supporting a patient in the prone position. In these embodiments, the portion of the mattress configured to be adapted to support a patient in the prone position may be referred to as a prone therapy region.

The mattress may comprise a prone therapy region. The prone therapy region of a mattress comprises a region that is configured to appropriately support at least a portion of a body of a patient in the prone position. A prone therapy region comprises at least a portion of the first layer of inflatable cells and a portion of the second layer of inflatable cells. In the prone therapy region, the portion of the second layer in the prone therapy region is below the portion of the first layer in the prone therapy region. In some embodiments, the prone therapy region comprises the entire first and second layers of inflatable cells.

The prone therapy region may extend across any suitable portion of the length and width of the mattress. Where a mattress is divided into zones along the length of the mattress, the prone therapy region may comprise or consist of one or more of the zones. In some embodiments, the prone therapy region extends across the entire length and width of the mattress.

In some contemplated embodiments, the first and second layers of inflatable cells comprise the same number of inflatable cells in the prone therapy region, each inflatable cell of the second layer being arranged below a corresponding inflatable cell of the first layer.

One or more of the valves of the valve system is fluidly connected to an inflatable cell in the prone therapy region. Each valve fluidly connected to an inflatable cell in the prone therapy region may enable the prone therapy region of the mattress to be configured or manipulated to appropriately support a patient on the support surface of the mattress in the prone position.

In some contemplated embodiments in which the mattress comprises a prone therapy region, each inflatable cell of the first layer in the prone therapy region is fluidly connected to a valve of the valve system, such that the valve system is configured to selectively enable inflation and deflation of each of the inflatable cells of the first layer individually in the prone therapy region.

In some contemplated embodiments in which the mattress comprises a prone therapy region, each inflatable cell of the second layer in the prone therapy region is fluidly connected to a valve of the valve system, such that the valve system is configured to selectively enable inflation and deflation of each of the inflatable cells of the second layer individually in the prone therapy region.

A mattress according to the present disclosure comprises a plurality of inflatable cells. The inflatable cells are connectable to a fluid supply device for inflating and deflating the plurality of inflatable cells. Optionally, each inflatable cell is provided with a connector for connecting the cell to a conduit of a fluid supply device. All of the cells of the first layer may be provided with a connector for connecting the cell to a conduit of a fluid supply device. All of the cells of the second layer may be provided with a connector for connecting the cell to a conduit of a fluid supply device. The connectors may be any suitable type of connector for connecting to a conduit of a fluid supply device. Typically a connector comprises a plastic connector for connecting to a pneumatic pipe or tube.

The mattress of the present disclosure includes a valve system comprising a plurality of valves. Each valve of the valve system is fluidly connected to one of the inflatable cells of the first and second layers of the mattress. Each valve is controllable to enable inflation and deflation of the cell to which it is fluidly connected. Each valve may be controllable to enable inflation and deflation of the cell to which it is fluidly connected independently of the other inflatable cells of the mattress.

In some embodiments, a valve of the valve system is the connector for connecting an inflatable cell to a fluid supply device. In some embodiments, a valve of the valve system is arranged between a fluid supply device and a connector of an inflatable cell.

The valves of the valve system may be any suitable type of valve. In some embodiments, the valves are manually operable. In other words, the valves are physically manipulable by a caregiver to select the position of the valves. As used herein, the term “manually operable” is used to describe a valve that is operable by a caregiver, such as by rotating a handle, rather than by a machine as part of an automated procedure.

In some embodiments, the valves of the valve system are connected to a controller and are operable by the controller. In these embodiments, the valves may be solenoid valves. The valves of the valve system may be connected to a controller of the fluid supply device and the controller may be configured to control the valve system. The fluid supply device may comprise a user interface configured to enable a caregiver to control the valves of the valve system.

In some embodiments, each inflatable cell of the first layer is fluidly connected to a valve of the valve system such that the valve system is configured to control the inflation and deflation of each of the cells of the first layer individually. In some embodiments, each inflatable cell of the second layer is fluidly connected to a valve of the valve system, such that the valve system is configured to control the inflation and deflation of each of the cells of the second layer individually.

Optionally, one or more of the valves of the valve system is a multiway valve. In other words, one or more of the valves of the valve system may be configured to selectively direct fluid from an inlet in one of two or more directions.

Optionally, each multiway valve comprises an inlet fluidly connectable to a fluid supply device. Optionally, each multiway valve comprises a plurality of outlets. Optionally each multiway valve is configured to selectively direct fluid from the inlet to one of the plurality of outlets. The one or more multiway valves may comprise a shutter that is movable to selectively direct fluid from the inlet to one of the plurality of outlets. Optionally, one of the outlets is connected to an inflatable cell of the first layer, one of the outlets is connected to an inflatable cell of the second layer, and one of the outlets is connected to an exhaust. Particularly optionally, one of the outlets is connected to an inflatable cell of the first layer, one of the outlets is connected to a first one of the cells of the second layer, one of the outlets is connected to an exhaust, and one of the outlets is connected to a second one of the cells of the second layer.

The one or more multiway valves may be any suitable type of multiway valve. The one or more multiway valves may be manually operable. For example, a manually operable multiway valve may be a ball-valve having a handle rotatable by a user to change the position of a ball shutter to selectively direct fluid from the inlet to one of the outlets. The one or more multiway valves may be controllable by a controller. For example, a multiway valve may be a solenoid valve having a shutter movable by an actuator connected to a controller to change the position of the shutter to selectively direct fluid from the inlet to one of the outlets. Where the one or more multiway valves are controllable by a controller, the one or more multiway valves may be connectable to and controllable by a controller of a fluid supply device.

In some contemplated embodiments, the first layer of inflatable cells has the same number of inflatable cells as the second layer of inflatable cells. In some of these contemplated embodiments, the valve system comprises the same number of multiway valves as the number of inflatable cells of the first layer, each multiway valve being fluidly connected to one inflatable cell of the first layer and at least one inflatable cell of the second layer.

In some first particularly contemplated embodiments of the first aspect of the present disclosure, the valve system comprises a multiway valve for each inflatable cell of the first layer of inflatable cells. In other words, the valve system comprises the same number of multiway valves as the number of inflatable cells in the first layer of the mattress. Optionally each inflatable cell of the first layer is fluidly connected to an outlet of a multiway valve of the valve system.

The valve system may comprise one or more multiway valves in the prone therapy region. Each multiway valve may be fluidly connected to an inflatable cell of the first layer in the prone therapy region. Each multiway valve may comprise: an inlet connectable to a fluid supply device; and a plurality of outlets, one of the outlets being connected to the inflatable cell of the first layer, one of the outlets being connected to a first one of the cells of the second layer, one of the outlets being connected to an exhaust, and one of the outlets being connected to a second one of the cells of the second layer, wherein each multiway valve is configured to selectively direct fluid from the inlet to one of the plurality of outlets.

In some first particularly contemplated embodiments, the first and second layers of inflatable cells in the prone therapy region comprise the same number of inflatable cells, and each inflatable cell of the second layer is arranged below a corresponding inflatable cell of the first layer. In these first particularly contemplated embodiments, each inflatable cell of the first layer in the prone therapy region may be fluidly connected to one of the multiway valves of the valve system, such that the valve system is configured to selectively enable inflation and deflation of each of the inflatable cells of the first layer in the prone therapy region individually.

In some first particularly contemplated embodiments, each multiway valve in the prone therapy region is arranged such that the first and second ones of the inflatable cells of the second layer that are fluidly connected to outlets of the multiway valve are arranged on opposite sides of the inflatable cell of the second layer that is arranged below the inflatable cell of the first layer fluidly connected to an outlet of the multiway valve. In other words, in embodiments in which a prone therapy region of the mattress comprises substantially identical first and second layers of inflatable cells, each cell of the first layer being aligned with a corresponding cell of the second layer, each cell of the first layer is fluidly connected to a multiway valve and each multiway valve is further connected to inflatable cells of the second layer arranged at either side of the cell of the second layer below the cell of the first layer. In this arrangement, each multiway valve is connected to three inflatable cells, one cell of the first layer and two cells of the second layer. As a result, each cell of the first layer in the prone therapy region is fluidly connected to one multiway valve and each cell of the second layer in the prone therapy region is fluidly connected to two multiway valves.

In this arrangement, each multiway valve is controllable to selectively direct fluid to: a cell of the first layer; a first cell of the second layer that is adjacent in a first direction to the cell of the second layer below the cell of the first layer; a second cell of the second layer that is adjacent in a second direction, opposite the first direction, to the cell of the second layer below the cell of the first layer; and an exhaust.

This particular arrangement of the one or more multiway valves is particularly suitable for use in mattresses in which the second layer of inflatable cells is intended to be used to perform the role of conventional support elements arrangeable on the support surface of a mattress for supporting a patient in the prone position. In such embodiments, the multiway valves may be directed to supply fluid to the cells of the first layer by default. When a multiway valve is in the default position, the cells of the second layer are not supplied with fluid, and so are deflated. When a patient is moved into the prone position on the mattress, the direction of one or more of the multiway valves may be adjusted to deflate one or more cells of the first layer or to deflate one or more cells of the first layer and inflate one or more cells of the second layer to appropriately support the patient in the prone position.

In one example adjustment, a multiway valve may be adjusted to direct fluid from the inlet to the exhaust to deflate a cell of the first layer. This type of adjustment may be used to provide clearance from the mattress for sensitive areas of a patient, such as the face of a patient.

In another example adjustment, a multiway valve may be adjusted to direct fluid from the inlet to one of the first and second cells of the second layer to deflate a cell of the first layer and inflate an adjacent cell of the second layer. Such an adjustment results in a reduction in the depth of the mattress at the position of the cell of the first layer and an increase in the depth of the mattress at the position of the adjacent cell of the second layer. This type of adjustment may be used to provide clearance from the mattress for one area of a patient and additional support for an adjacent part of the patient, such as providing clearance for the feet of a patient and additional support for the ankles of the patient.

Optionally, providing a mattress with two layers of inflatable cells and fluidly connecting the inflatable cells with multiway valves as described above may enable the mattress to be configured to appropriately support a patient in the prone position. Such an arrangement may enable a mattress to provide a standard mattress depth when a cell of the first layer is inflated and a cell of the second layer arranged below the cell of the first layer is deflated, and may enable the mattress to provide a greater depth than that of a standard mattress when both of the cells are inflated. In this way, the select inflated cells of the second layer may be used to perform the role of conventional support elements, such as pads or cushions, arranged on top of the support surface of a mattress. Optionally, providing a mattress with a layer of inflatable cells that are able to perform the role of conventional support elements arranged on the support surface of a mattress may enable a caregiver to configure the mattress to appropriately support a patient in the prone position, without the caregiver being required to handle the patient.

In some second particularly contemplated embodiments of the first aspect of the present disclosure, there is provided a mattress comprising: a support surface for supporting the body of a patient; a plurality of inflatable cells arranged below the support surface, and a valve system comprising a plurality of valves. The mattress has a length and is divided along its length into a plurality of zones. The plurality of inflatable cells is arranged in layers comprising: a first layer of inflatable cells arranged below the support surface; and a second layer of inflatable cells arranged below the first layer, wherein each inflatable cell of the first layer is arranged above at least one cell of the second layer. The second layer comprises a plurality of inflatable cells arranged such that a different inflatable cell is positioned in each zone of the mattress. Each valve of the valve system is fluidly connected to an inflatable cell of the second layer and is controllable to enable inflation and deflation of the inflatable cell of the second layer.

In some second particularly contemplated embodiments, the mattress comprises at least five zones. The zones include a head zone at a head end of the mattress, a shoulder zone, an abdominal zone, a pelvic zone and a leg zone. Furthermore, the second layer comprises at least five inflatable cells, each of the five inflatable cells occupying a different zone of the mattress.

In some second particularly contemplated embodiments, adjacent inflatable cells of adjacent zones of the first layer are held together. In some embodiments, adjacent inflatable cells of adjacent zones of the first layer are bonded together. In some embodiments, all adjacent cells of the first layer are held together. The inflatable cells of the first layer may be surrounded or enclosed in a cover to hold together the cells of the first layer in a particular arrangement.

Holding together adjacent cells of adjacent zones of the first layer may enable inflatable cells of the first layer arranged above a deflated inflatable cell of the second layer to be held, by the adjacent cells of the adjacent zones, above the space that would be occupied by the cell of the second layer if the cell of the second layer was inflated. Put in another way, cells of the first layer above a deflated cell of the second layer may be supported at both ends above that would be occupied by the cell of the second layer if the cell of the second layer was inflated in the manner of a hammock. Such “hammocked” cells of the first layer, arranged over deflated cells of the second layer and supported by adjacent inflatable cells at both ends, may provide some support to the body of a patient supported on the mattress, but with a lower interface pressure than if the deflated cell of the second layer had been inflated. Accordingly, such a mattress configuration may enable the local interface pressure between a portion of a patient and the mattress to be reduced, without completely removing the support of the mattress from that portion of the patient. Since the “hammocked” cells of the first layer continue to provide some support to a patient supported on the mattress, the interface pressure between the patient and the mattress at other areas of the patient may not be significantly increased.

The head of a patient is a particularly sensitive area of the patient to support when a patient is supported on a mattress in the prone position, as the face of the patient is required to be supported. Accordingly, the inflatable cells of the first and second layers of the head zone of a mattress may be configured to be deflated when a patient is supported on the mattress in the prone position. Deflation of the cells of the first and second layers of the mattress in the head zone may enable a head support element to be arranged on the support surface at the head zone to appropriately support the head of a patient. A head support element may be an element that has been specifically designed to support the face of a patient, for example by providing a cavity or an open passage that may be positioned over one or more of the eyes, nose and mouth of a patient. A head support element may be a cushion, pillow or gel pad. The depth of a head support element may be substantially similar to the depth at least one of an inflatable cell of the first or second layer of the mattress. This may enable a support surface of the head support element to be substantially aligned with the support surface of the mattress in the zone adjacent to the head zone of the mattress when the mattress is configured to support a patient in the prone position with the inflatable cells of the first and second layers of the head zone deflated and the head support element arranged on the support surface of the mattress at the head zone.

To configure the mattress of the second particularly contemplated embodiment to support a patient in the prone position, the inflatable cells of the second layer may be inflated or deflated in a particular configuration. Optionally, the one or more inflatable cells of the second layer in the head zone are deflated to enable a head support element to be arranged on the head zone of the support surface. Optionally, the one or more inflatable cells of the second layer in the shoulder zone are inflated at a continuous pressure. Optionally, the one or more inflatable cells of the second layer in the abdominal zone are deflated. Optionally, the one or more inflatable cells of the second layer in the pelvic zone are deflated to reduce the interface pressure between the pelvis of the patient and the mattress. Optionally, the one or more inflatable cells of the second layer in the leg zone may be inflated at continuous pressure. In such a configuration, the inflatable cells of the first layer in the abdominal and pelvic zones may be arranged over deflated cells of the second layer and supported at both ends by the adjacent cells of the shoulder zone and the leg zone. In other words, the inflatable cells of the abdominal zone and the pelvic zone are “hammocked.” Optionally, the inflatable cells of the first layer in the head zone are deflated to enable a head support element to be arranged on the support surface of the mattress in the head zone. Optionally, the inflatable cells of the first layer outside of the head zone are inflated and deflated according to an alternating-pressure mode.

In some second particularly contemplated embodiments, the first layer of inflatable cells are arranged side-by-side in a row extending along the length of the mattress, from a head end to a foot end, each adjacent cell of the first layer being held together. The second layer of inflatable cells may also be arranged side-by-side in a row extending along the length of the mattress, from the head end to the foot end.

The mattress may be sized to accommodate patients of any size. For example, the mattress may be sized to accommodate an infant patient or an adult patient. In some embodiments, the mattress may be sized to accommodate a bariatric patient. The mattress may be sized to accommodate any desired number of patients.

Typically, the mattress has a length extending in a longitudinal direction, a width extending in a transverse direction, perpendicular to the longitudinal direction, and a depth or height extending in a transverse direction perpendicular to the longitudinal direction and the transverse direction of the width.

As used herein, the term “length” refers to the maximum dimension in the longitudinal direction. The terms “width” and “diameter” refer to the maximum dimension in a transverse direction, perpendicular to the longitudinal direction. The term “transverse cross-section” refers to a section that is cut in a transverse direction, perpendicular to the longitudinal direction. The term “depth” refers to the maximum dimension in a direction perpendicular to both the longitudinal direction and the transverse direction of the width.

The mattress may have any suitable length. For example, the length of the mattress may be between about 1800 millimeters and about 2500 millimeters, between about 1900 millimeters and about 2300 millimeters, or between about 1800 millimeters and about 2200 millimeters.

The mattress may have any suitable width. The mattress may have a width suitable for accommodating any desired number of people. For example, the mattress may be a single or a double mattress. Optionally, the mattress is a single mattress, suitable for accommodating a single adult patient. Where the mattress is a single mattress, the width of the mattress, in particular the width of the support surface of the mattress, may be between about 700 millimeters and about 1100 millimeters, between about 800 millimeters and about 1000 millimeters, or between about 850 millimeters and about 900 millimeters.

The mattress may have any suitable depth. The depth of the mattress may vary depending on the inflation and deflation of the inflatable cells. In some of the first particularly contemplated embodiments, when the inflatable cells of the first layer are inflated and the inflatable cells of the second layer are deflated, the mattress may have a depth of between about 150 millimeters and about 250 millimeters, between about 160 millimeters and about 230 millimeters or between about 170 millimeters and about 220 millimeters. In these first particularly contemplated embodiments, when the inflatable cells of the first layer are deflated and the inflatable cells of the second layer are inflated, the mattress may have a depth of between about 180 millimeters and about 400 millimeters, between about 180 millimeters and about 380 millimeters, or between about 180 millimeters and about 350 millimeters. Accordingly, inflation of the inflatable cells of the second layer may cause the depth of the mattress to increase by between about 30 millimeters and about 250 millimeters, depending on the size and arrangement of the inflatable cells of the second layer.

The layers of inflatable cells may be arranged in any suitable arrangement in the mattress. Optionally, each layer of the mattress extends substantially across the width of the mattress and substantially across the length of the mattress. In other words, the first and second layers optionally have a length that is substantially equal to the length of the mattress and have a width that is substantially equal to the width of the mattress. As such, the mattress may be comprised of a stack of layers of inflatable cells. The depth of the mattress may be substantially equal to the combined depth of the layers of inflatable cells. The mattress may comprise any suitable number of layers of inflatable cells. For example, the mattress may comprise two, three, four, five or six layers of inflatable cells.

The first layer of inflatable cells comprises a plurality of inflatable cells. The first layer may comprise any suitable number of inflatable cells. For example, the first layer may comprise between 2 and 100 inflatable cells, between 4 and 60 inflatable cells, or between 5 and 40 inflatable cells. The first layer may comprise at least 2 inflatable cells, at least 3 inflatable cells, at least 4 inflatable cells or at least 5 inflatable cells. The first layer may comprise 20 inflatable cells.

The second layer of inflatable cells comprises a plurality of inflatable cells. The second layer may comprise any suitable number of inflatable cells. For example, the second layer may comprise between 2 and 100 inflatable cells, between 4 and 60 inflatable cells, or between 5 and 40 inflatable cells. The second layer may comprise at least 2 inflatable cells, at least 3 inflatable cells, at least 4 inflatable cells or at least 5 inflatable cells. The first layer may comprise 20 inflatable cells.

In some embodiments, the first layer of inflatable cells has the same number of inflatable cells as the second layer of inflatable cells. In these embodiments, each cell of the second layer may be arranged below a cell of the first layer. The first layer may be substantially identical to the second layer and the inflatable cells of the first layer may be aligned with the inflatable cells of the second layer.

In some embodiments, the first layer and the second layer have different numbers of inflatable cells.

In some embodiments, the first layer of inflatable cells are arranged side-by-side in a row. The row may extend along the length of the mattress, from a head end to a foot end. In other words, the inflatable cells of the first layer may be disposed, side-by-side, in the longitudinal direction of the mattress.

In some embodiments, the second layer of inflatable cells are arranged side-by-side in a row. The row may extend along the length of the mattress, from a head end to a foot end. In other words, the inflatable cells of the second layer may be distributed or disposed, side-by-side, in the longitudinal direction of the mattress.

In some embodiments, the mattress comprises a third layer arranged below the second layer. The third layer may comprise one or more non-inflatable elements, such as a body of foam. Optionally, the third layer comprises at least one inflatable cell. In some contemplated embodiments, the plurality of inflatable cells comprise a third layer comprising at least one inflatable cell, wherein each inflatable cell of the second layer is arranged above at least one inflatable cell of the third layer. In some particularly contemplated embodiments, the third layer comprises one inflatable cell that substantially extends the length and width of the mattress.

The inflatable cells may be any suitable shape and size. In some embodiments, the inflatable cells have different shapes and sizes. The inflatable cells of the first layer may have different shapes and sizes or may all have the same shape and size. The inflatable cells of the second layer may have different shapes and sizes or may all have the same shape and size. In some embodiments, all of the inflatable cells have the same shape and size.

One or more of the inflatable cells may be elongate. In other words, one or more of the inflatable cells may have a length that is greater than the other dimensions of the cell, such as the diameter of the cell.

One or more of the inflatable cells may extend in the direction of the width of the mattress. One or more of the inflatable cells may extend substantially the width of the mattress. In other words, one or more of the inflatable cells may have a length that is substantially equal to the width of the mattress. In some contemplated embodiments, all of the inflatable cells of the first layer extend transversely across the mattress, from one side to the other. In some contemplated embodiments, all of the inflatable cells of the second layer extend transversely across the mattress, from one side to the other.

The inflatable cells may have any suitable transverse cross-section shape when inflated. For example, one or more of the inflatable cells may have a circular, oval, square or stadium shaped transverse cross-section.

The inflatable cells comprise substantially cylindrical sausage-shaped tubes. In some particularly contemplated embodiments, all of the inflatable cells comprise substantially cylindrical sausage-shaped tubes.

The inflatable cells may comprise a casing defining the cell. The casing may be formed from any suitable material. The casing may be formed from a polymeric material, in particular a thermoplastic polymer such as polyurethane. Such a material offers the characteristics of being both flexible and strong and, by being thermoplastic, of being sensitive to human body heat, thereby enhancing the comfort and the flexibility of the support provided for an individual on the mattress. In some embodiments, the casing may be formed from a polyurethane coated nylon.

All of the inflatable cells of the first layer may have a casing formed from the same material. All of the inflatable cells of the second layer may have a casing formed from the same material. In some embodiments, all of the inflatable cells of the first and second layers have a casing formed from the same material.

In embodiments comprising a third layer the one or more inflatable cells of the third layer may have a casing formed from a material that has a lower flexibility than the material of the casing of the inflatable cells of the first and second layers. Optionally, this may improve the ability of the third layer to maintain a geometrical shape compared to the inflatable cells of the first and second layers, while enabling the first and second layers to provide a sufficiently comfortable support surface for a patient support on the mattress. In some embodiments, the one or more inflatable cells of the first and second layers have a casing formed from polyurethane and the one or more cells of the third layer have a casing formed from a polyurethane coated nylon.

Adjacent inflatable cells in a layer may be held together. This may enable a layer of inflatable cells to hold a particular geometric shape. Adjacent inflatable cells of a layer may be held together by any suitable means. Some adjacent inflatable cells of a layer may be secured together by releasable fastening means, such as press studs. Some adjacent inflatable cells may be bonded together. Adjacent inflatable cells of a layer may be bonded together by any suitable means. For example, adjacent inflatable cells may be welded together. In some embodiments, a layer of inflatable cells may be formed by flat butt welding together two sheets of material, such as polyurethane, along weld lines that are mutually parallel.

In some embodiments, all adjacent cells of the first layer are bonded together. In some embodiments, all adjacent cells of the second layer are bonded together.

One or more of the layers of inflatable cells may be surrounded or enclosed by a cover. A cover may help to protect the inflatable cells from damage, may help to maintain the desired geometric shape of the mattress and may reduce the ingress of moisture into the mattress. In embodiments in which some of the cells of a layer are not bonded to adjacent cells of the layer, a cover surrounding or enclosing the layer may help to keep together the cells of the layer in a desired arrangement or geometric shape. A cover surrounding or enclosing all of the layers of inflatable cells may help to keep together the layers of cells in a desired arrangement or geometric shape. One or more of the inflatable cells may be releasably secured to the cover.

A cover may be formed from any suitable material. Suitable materials include any of the materials suitable for the casing enclosing all of the inflatable cells. Optionally, a cover is formed from a bacteriostatic material. Optionally, a cover is formed from a fungistatic material. Optionally, a cover is formed from an antimicrobial material. A cover may be formed from a material that is permeable to water vapor. A cover may be formed from a material that is impermeable to water vapor. The cover may be formed from a woven or a non-woven fabric.

The mattress is connectable to a fluid supply device for inflating and deflating the plurality of inflatable cells. Typically, the fluid supply device comprises a compressor that is fluidly connectable to the plurality of inflatable cells and operable to supply fluid to the plurality of inflatable cells to inflate the cells and a controller configured to control the supply of fluid to the inflatable cells to control inflation and deflation of the of cells. Typically, the fluid supply device further comprises a fluid supply conduit, such as a manifold, for fluidly connecting the compressor and the plurality of inflatable cells. A plurality of valves may be provided in the fluid supply conduit for controlling the supply of fluid through the fluid supply conduit. The valves may be connected to the controller of the fluid supply device and controllable by the controller of the fluid supply device.

The fluid supply device may be configured to inflate and deflate the inflatable cells of the first layer in accordance with one or more therapy modes or programs. In such embodiments, the first layer may be referred to as a therapy layer. For example, the inflatable cells of the first layer may be inflated and deflated in accordance with an “alternating-pressure mode” in which certain inflatable cells of the first layer are inflated and deflated simultaneously, and in alternation.

Configuring a controller of a fluid supply device to control solenoid valves in a fluid supply manifold to regulate inflation and deflation of the inflatable cells of the mattress may make it possible for a mattress to be operated in such an alternating-pressure mode. For example, one in every two elements, or two in every three elements, or one in every four elements may be deflated and re-inflated, and then the elements adjacent to the previously deflated and re-inflated compartments may be deflated and re-inflated. Thus, each inflatable element of the mattress may be deflated/re-inflated in succession, one after another, thereby creating a sort of wave moving back and forth in the longitudinal direction of the mattress and relieving the interface pressure between a patient and the mattress locally. This can facilitate blood circulation through the soft tissue at the interface with the surface of the mattress.

In some particularly contemplated embodiments, the inflatable cells of the second layer may be deflated by default, and may be selectively inflated by a caregiver operating one or more valves of the valve system of the mattress, as discussed in more detail below. Optionally, this may enable the inflatable cells of the second layer to be used in the manner of conventional support elements placed on a support surface of a mattress to adequately support a patient in the prone position. As such, in these contemplated embodiments, the second layer may be referred to as a prone layer. In some of these contemplated embodiments, the inflatable cells of the first layer may also be selectively inflated or deflated by a caregiver operating one or more of the valves of the valve system.

In some embodiments comprising a third layer of one or more inflatable cells arranged below the second layer, the third layer may be inflated by default. Inflating the third layer by default may ensure that a patient supported on the mattress does not contact a support apparatus on which the mattress is supported if the cells of the first and second layers are deflated, but rather contacts the one or more inflatable cells of the third layer. In these embodiments, the third layer may be referred to as a safety layer. The third layer may be inflated independently of the first and second layers, and may be fluidly connected to a separate fluid supply device from the first and second layers.

According to a second aspect of the present disclosure, there is provided a mattress system comprising: a mattress according to the first aspect of the present disclosure, as described above, and a fluid supply device.

The fluid supply device comprises: a compressor fluidly connected to the plurality of inflatable cells and operable to supply fluid to the plurality of inflatable cells to inflate the cells. The mattress system also comprises a controller configured to control the supply of fluid to the inflatable cells to control the inflation and deflation of the cells.

The compressor may be any suitable type of device for supplying fluid, optionally air, to the inflatable cells.

The controller may be any suitable type of controller for controlling the operation of the compressor. Typically, the controller comprises a microprocessor. Optionally, the fluid supply device further comprises a user interface connected to the controller and configured to enable a caregiver to control operation of the fluid supply device. The user interface may be a graphical user interface, such as a touch screen display device. The user interface may be connected to the controller by any suitable wired or wireless connection. Where the user interface is connected to the controller by wireless connection, the user interface may be a portable device of the caregiver, such as a smartphone or a tablet computer including appropriate software. The wireless connection may use any suitable wireless transmission protocol, such as an IEEE 802.11, Wi-Fi®, protocol over a local area network (LAN), an infrared transmission protocol, such as an IrDA protocol, Bluetooth®, or any other suitable wireless transmission protocol. Where the connection is a wired connection, the system may use any standard transmission protocol, such as TCP/IP or RS232.

Optionally, the fluid supply device comprises one or more fluid supply conduits. The one or more fluid supply conduits fluidly connect the compressor to the plurality of inflatable cells of the mattress. Each fluid supply conduit comprises an inlet for connection to a fluid supply device. Each fluid supply conduit further comprises a plurality of outlets for connection to the plurality of inflatable cells of the mattress. As such, each fluid supply conduit may be a manifold. The one or more fluid supply conduits may comprise any suitable type of conduit for fluidly connecting the compressor to the plurality of inflatable cells. Typically, the one or more fluid supply conduits comprise pneumatic pipes of tubes. Optionally, the pipes or tubes are sized and arranged to connect to the connectors or valves of each of the inflatable cells of the mattress.

Where a valve of the valve system of the mattress is fluidly connected to an inflatable cell, the valve may be arranged between the fluid supply conduit and the inflatable cell. The outlet of the fluid supply device may be fluidly connected to an inlet of the valve. In some embodiments, a valve may be arranged between the fluid supply device and a connector of the inflatable cell for connecting the inflatable cell to a fluid supply conduit. In some embodiments, the valve may be the connector of the inflatable cell.

The fluid supply device may comprise a plurality of fluid supply conduits. The fluid supply device may comprise a plurality of fluid supply conduits, each supply conduit being arranged to supply fluid to a layer of the inflatable cells. In some embodiments, the one or more fluid supply conduits may comprise a first layer supply conduit for supplying fluid to the first layer of inflatable cells. In some embodiments, the one or more fluid supply conduits may comprise a second layer supply conduit for supplying fluid to the second layer of inflatable cells of the first layer.

Each inflatable cell of the first layer may be fluidly connected to a first layer supply conduit. Each inflatable cell of the first layer may be fluidly connected to a first layer supply conduit such that each inflatable cell of the first layer is fluidly connected to at least one other inflatable cell of the first layer, in parallel, via a first layer supply conduit.

As used herein, the term “fluidly connected in parallel” refers to two inflatable cells being connected to a fluid supply conduit so that in use air flowing along a first layer supply conduit is divided into a first air stream that is supplied to a first one of the cells and a second air stream that is supplied to a second one of the cells.

Each inflatable cell of the second layer may be fluidly connected to a second layer supply conduit. Each inflatable cell of the second layer may be fluidly connected to a second layer supply conduit such that each inflatable cell of the second layer is fluidly connected to at least one other inflatable cell of the second layer, in parallel, via a second layer supply conduit.

Optionally, the fluid supply device comprises a plurality of valves arranged to control the supply of fluid to the plurality of inflatable cells. Each fluid supply conduit may also comprise a valve arranged to control the supply of fluid through the fluid supply conduit.

The valves may be any suitable type of valve. In some embodiments, the valves are manually operable. Optionally, the valves are controllable by a controller. The valves may be connected to the controller of the fluid supply device and controllable by the controller to control the supply of fluid from the fluid supply device to the inflatable cells of the mattress. For example, the valves may be solenoid valves connected to the controller of the fluid supply device.

Each valve of the fluid supply device may be configured to enable exhaust to atmosphere. This may enable each zone or layer to be deflated rapidly, if desired. For example, it may be desirable for both the first and second layers of inflatable cells to be deflated when performing CPR on a patient, and so it may be desirable to provide an arrangement of valves that is capable of enabling rapid deflation of the first and second layers in a CPR mode.

In some particularly contemplated embodiments, there is provided a mattress system comprising: a mattress and a fluid supply device. The mattress comprises: a support surface for supporting the body of a patient; a plurality of inflatable cells arranged below the support surface; and a valve system. The plurality of inflatable cells are arranged in layers comprising: a first layer of inflatable cells arranged below the support surface; and a second layer of inflatable cells arranged below the first layer, wherein each inflatable cell of the first layer is arranged above at least one cell of the second layer. The valve system comprises a plurality of valves, each valve being fluidly connected to an inflatable cell of the second layer and each valve being controllable to enable inflation and deflation of the inflatable cell. The fluid supply device comprises: a compressor fluidly connectable to the plurality of inflatable cells and operable to supply fluid to the plurality of inflatable cells to inflate the cells; and a controller configured to control the supply of fluid to the plurality of inflatable cells to control inflation and deflation of the plurality of cells. The controller is configured to supply fluid to the first layer of inflatable cells in one of a continuous pressure mode, in which the cells of the first layer are inflated at a substantially continuous pressure, and an alternating-pressure mode, in which cells of the first layer are inflated and deflated simultaneously, and in alternation. The controller is further configured to supply fluid to the second layer of inflatable cells in a continuous pressure mode, in which the cells of the first layer are inflated at a substantially continuous pressure. Adjacent cells of the first layer are held together, and the inflatable cells of the second layer are selectively deflatable on actuating the valves of the valve system.

This particularly contemplated embodiment provides the same features described above in relation to the second particularly contemplated embodiment.

According to a third aspect of the present disclosure, there is provided a patient support apparatus comprising: a mattress having a support surface for supporting the body of a patient, the mattress comprising a head end and a foot end, opposite the head end; a frame for supporting a mattress; and a head support configured to extend beyond the head end of the mattress, supported by the frame, to support the head of a patient supported on the mattress in a prone position.

In some embodiments, the head support is removably securable to the frame.

In some embodiments, the head support is retractable into the frame for storage and extendable from the frame for use. The head support may be movable relative to the frame between a retracted position, in which the head support is arranged beneath the mattress, and an extended position, in which the head support extends beyond the head end of the mattress and is supported by the frame.

Optionally, the head support comprises a headrest for supporting the head of a patient supported on the mattress and a head support frame for supporting the headrest on the frame of the patient support apparatus.

The headrest may have any suitable shape and be formed from any suitable material to comfortably support the head of a patient. In some embodiments, the headrest may be compressible. For example, the headrest may be a cushion, gel pad or pillow. The headrest may be formed from a foam material. In some contemplated embodiments, the headrest is formed from a viscoelastic foam material.

The head rest may comprise one or more inflatable cells. Optionally, the head rest comprises a plurality of inflatable cells. The one or more inflatable cells may be fluidly connectable to a fluid supply device. The fluid supply device may be the same fluid supply device that is fluidly connected to the mattress to control inflation and deflation of one or more inflatable cells of the mattress. The one or more inflatable cells may be arranged in any suitable arrangement to appropriately support the head of a patient in the prone position.

Inflation and deflation of the plurality of inflatable cells may be controlled by the fluid supply device in any suitable manner. Inflation and deflation of the plurality of inflatable cells may be controlled by the fluid supply device in an alternating-pressure mode, as described above for the first layer of cells of the mattress. Inflating and deflating the inflatable cells of the head rest in an alternating-pressure mode may further reduce the risk of pressure injuries forming on the face of a patient.

The headrest may comprise a cavity for receiving a portion of the head of a patient. The headrest may be configured to support the periphery of the head of a patient and to receive the sensitive central areas of the head of a patient, such as the eyes, nose and mouth, in the cavity. In some embodiments, the cavity may be an open cavity. In other words, the headrest may comprise a passage open at both ends, through which intubation or tracheotomy tubes may pass. In some embodiments, the headrest may be substantially annular. In some embodiments, the headrest may be substantially arcuate or U-shaped. Where the headrest comprises a plurality of inflatable cells, the inflatable cells may be arranged or disposed around the cavity.

In some embodiments, the head support may comprise one or more shoulder rests for supporting the shoulders of a patient supported on the mattress. Optionally, the head support comprises two shoulder rests arranged at opposite sides of the headrest. The shoulder rests may be formed from any suitable material to comfortably support the shoulders of a patient. Suitable materials include any materials suitable for the headrest of the head support.

In some embodiments, the head support frame is removably couplable to the frame of the patient support apparatus. Optionally, this may enable the head support to be fitted to a patient support apparatus when desired.

In some embodiments, the head support frame is movably coupled to the frame of the patient support apparatus. The head support frame may be movably coupled to the frame of the patient support apparatus in any suitable manner. For example, the head support frame may be slidably, rotatably or foldably connected to the frame of the patient support apparatus.

In some embodiments, the head support frame may be slidable relative to the frame of the patient support apparatus. In these embodiments, the head support frame may be slidable connected to the frame of the patient support apparatus by one or more rails on the frame of the patient support apparatus.

In some embodiments, the head support frame may be pivotally or hingedly connected to the frame of the patient support apparatus. In these embodiments, the head support frame may be rotatably connected to the frame of the patient support apparatus by one or more hinges.

In some embodiments, the head support frame may comprise one or more linkages. The head support frame may comprise a plurality of linkages. In some contemplated embodiments, the head support frame may comprise a plurality of scissor linkages. In other words the head support frame may comprise a plurality of pantographs, such that the head support frame may be moved between the extended position and the retracted position in the manner of an accordion.

The head support frame may comprise a platform on which the headrest, and optionally one or more shoulder rests, may be supported. The platform may extend from the head end of the frame of the patient support apparatus. The platform may comprise a cavity or an open passage arrangeable beneath one or more of the eyes, nose and mouth of a patient.

The head support frame may comprise one or more arms extending from the head end of the frame of the patient support apparatus. Optionally, the head support frame may comprise two arms extending from the head end of the frame of the patient support apparatus to support both sides of the headrest. Where the head support frame comprises two arms extending from the head end of the frame of the patient support apparatus, each arm may support a shoulder rest of the patient towards the end of the arm supported by the frame of the patient support apparatus. The head support frame may comprise a headrest support movably coupled to one or more of the arms. The headrest support may be configured to support the headrest and adjust the position and orientation of the headrest as desired to appropriately support the head of a patient. The headrest support may be movably coupled to one or more of the arms in any suitable manner.

The height of the head support frame may be adjustable relative to the height of the mattress.

It will be appreciated that features described in relation to one aspect of the present disclosure may also be applied equally to the other aspects of the present disclosure. In particular, features described in relation to the mattress of the present disclosure may be applied equally to the mattress system of the present disclosure and vice versa.

### BRIEF DESCRIPTION OF THE DRAWINGS

The disclosure will be further described, by way of example only, with reference to the accompanying drawings, in which:

FIG. 1 shows a schematic illustration of a mattress according to a first embodiment of the present disclosure;

FIG. 2 shows a schematic illustration of the mattress of FIG. 1 with some inflatable cells of the second layer deflated;

FIG. 3 shows a schematic illustration of the mattress of FIG. 2 supporting a patient in the prone position;

FIG. 4 shows a schematic illustration of a multiway valve for a mattress of a second embodiment of the present disclosure;

FIG. 5 shows a schematic illustration of a mattress of a second embodiment of the present disclosure comprising a plurality of the multiway valves of FIG. 4;

FIG. 6 shows a schematic illustration of a mattress of FIG. 5 with some inflatable cells of the first layer deflated and some inflatable cells of the second layer inflated;

FIG. 7 shows a schematic illustration of the mattress of FIG. 5 configured to support a patient in the prone position;

FIG. 8 shows a schematic illustration of the mattress of FIG. 7 supporting a patient in the prone position;

FIG. 9 shows a schematic view of a fluid supply conduit for use with the mattress of FIG. 5;

FIG. 10 shows a schematic plan illustration of a mattress having a head support according to a third embodiment of the present disclosure;

FIG. 11 shows a schematic side illustration of the mattress of FIG. 10;

FIG. 12 shows a schematic plan illustration of a mattress having a head support according to a fourth embodiment of the present disclosure;

FIG. 13 shows a schematic side illustration of the mattress of FIG. 12; and

FIG. 14 shows a schematic plan illustration of a headrest for a head support of the mattresses of FIG. 10 or FIG. 12.

### DETAILED DESCRIPTION

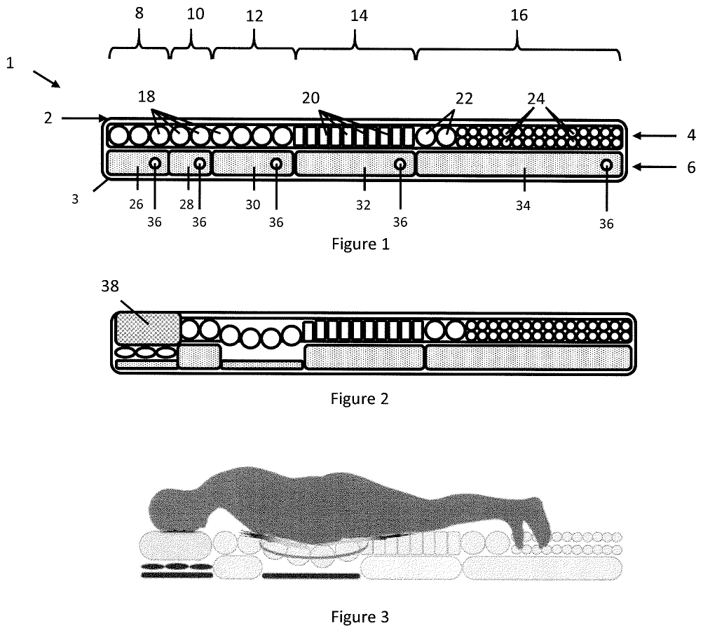

FIGS. 1-3 show schematic illustrations of a mattress 1 according to a first embodiment of the present disclosure.

The mattress 1 comprises a support surface 2 for supporting a body of a patient. The mattress 1 further comprises a plurality of inflatable cells arranged below the support surface 2 and contained in a removable cover 3. The plurality of inflatable cells are arranged in layers comprising: a first layer 4 of inflatable cells arranged directly below the support surface 2; and a second layer 6 of inflatable cells arranged directly below the first layer 4. Each inflatable cell of the first layer 4 is arranged above at least one cell of the second layer 6.

The support surface 2 is generally rectangular and has a length and a width. The first layer 4 extends the entire length and width of the support surface 2, such that an upper surface of the first layer 4 substantially forms the support surface 2. The second layer 6 also extends the entire length and width of the support surface 2, such that each inflatable cell of the first layer 4 is supported over the entire length and width of the cell by at least one cell of the second layer 6.

The mattress is divided along its length into a plurality of zones. In this embodiment, the mattress is divided into five zones as follows: a head zone 8 at a head end of the mattress, a shoulder zone 10, an abdominal zone 12, a pelvic zone 14 and a leg zone 16, at a foot end of the mattress, opposite the head end. The head zone 8 is arranged to support the head of a patient supported on the mattress; the shoulder zone 10 is arranged to support the shoulders of a patient supported on the mattress; the abdominal zone 12 is arranged to support the abdomen of a patient supported on the mattress; the pelvic zone 14 is arranged to support the pelvis of a patient supported on the mattress; the leg zone 16 is arranged to support the legs and feet of a patient supported on the mattress.

The first layer 4 is formed by juxtaposing inflatable cells that are generally in the form of sausage-shaped tubes extending in the direction of the width of the mattress. The cells of the first layer 4 are generally disposed side-by-side in a row in the direction of the length of the mattress.

The inflatable cells of the first layer 4 are not all identical, and vary depending on the zone in which the inflatable cell is positioned. The inflatable cells 18 in the head zone 8, the shoulder zone 10 and the abdominal zone 12 of the first layer 4 are substantially identical, and have a circular cross-section with a diameter substantially equal to the depth of the first layer 4, when the cells are inflated. The inflatable cells 20 in the pelvic zone 14 of the first layer 4 have a rectangular cross-section with a depth substantially equal to the depth of the first layer 4 when the cells are inflated. The leg zone 16 of the first layer 4 comprises two different types of inflatable cell. The first inflatable cells 22 in the leg zone 16, positioned adjacent to the cells 20 of the pelvic zone, are the same as the inflatable cells 16 in the head zone 8, shoulder zone 10 and abdominal zone 12. The second inflatable cells 22 in the leg zone 16, positioned between the first inflatable cells 22 and the foot end of the mattress, have a circular cross-section with a diameter substantially equal to half the depth of the first layer 4. The second cells 22 in the leg zone 16 of the first layer 4 are arranged in two sub-layers, one sub-layer being positioned on top of the other.

The inflatable cells of the first layer 4 are formed in segments, each segment comprising a plurality of inflatable cells bonded to one another and formed by flat butt welding (e.g., heat-sealing) together two sheets of polyurethane, along weld lines that are mutually parallel. A first segment comprises the inflatable cells 18 of the head zone 8 of the first layer 4. A second segment comprises the inflatable cells 18 of the shoulder zone 10 and abdominal zone 12. A third segment comprises the inflatable cells 20 of the pelvic zone 14. A fourth segment comprises the first inflatable cells 22 of the leg zone 16. Fifth and sixth segments comprise each sub-layer of the second inflatable cells 24 of the leg zone 16.

Each of the segments of the first layer 4 is secured to the cover 3 by plastic press studs (not shown). Each of the second, third, fourth, fifth and sixth segments of inflatable cells of the first layer 4 are also secured to the adjacent segments of the first layer 4 by plastic press studs (not shown) placed in such a manner as to guarantee that the adjacent segments are held together mechanically, while also being releasable. The first segment is not secured to the adjacent second segment by plastic press studs. The plastic press studs make disassembly possible in the event that the first layer 4 is replaced in full or in part by replacing one or more of the segments.

The second layer 6 is also formed by juxtaposing inflatable cells that are generally in the form of sausage-shaped tubes extending in the direction of the width of the mattress. The cells of the second layer 6 are also generally disposed side-by-side in a row in the direction of the length of the mattress. The inflatable cells of the second layer 6 all have a substantially rectangular transverse cross-section with a depth substantially equal to the depth of the second layer 6, when the cell is inflated.

The second layer 6 comprises one inflatable cell in each zone of the mattress. Specifically, the second layer 6 comprises one inflatable cell 26 in the head zone 8, one inflatable cell 28 in the shoulder zone 10, one inflatable cell 30 in the abdominal zone 12, one inflatable cell 32 in the pelvic zone 14 and one inflatable cell 34 in the leg zone 34. Each of the inflatable cells of the second layer 6 substantially extends across the entire length and width of the zone in which the cell is located. As such, each inflatable cell of the first layer 4 is arranged above an inflatable cell of the second layer 6. Adjacent inflatable cells of the second layer 6 are not directly secured together, but each cell of the second layer 6 is secured to the cover 3 by plastic press studs (not shown).

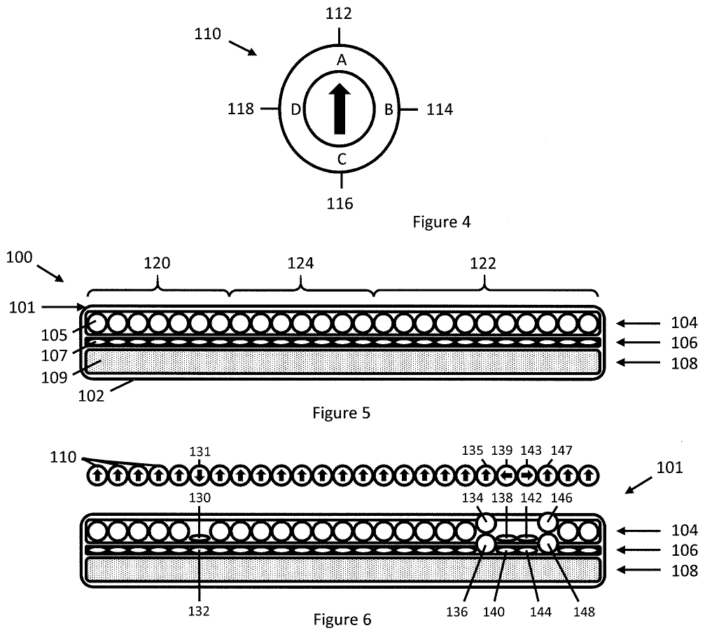

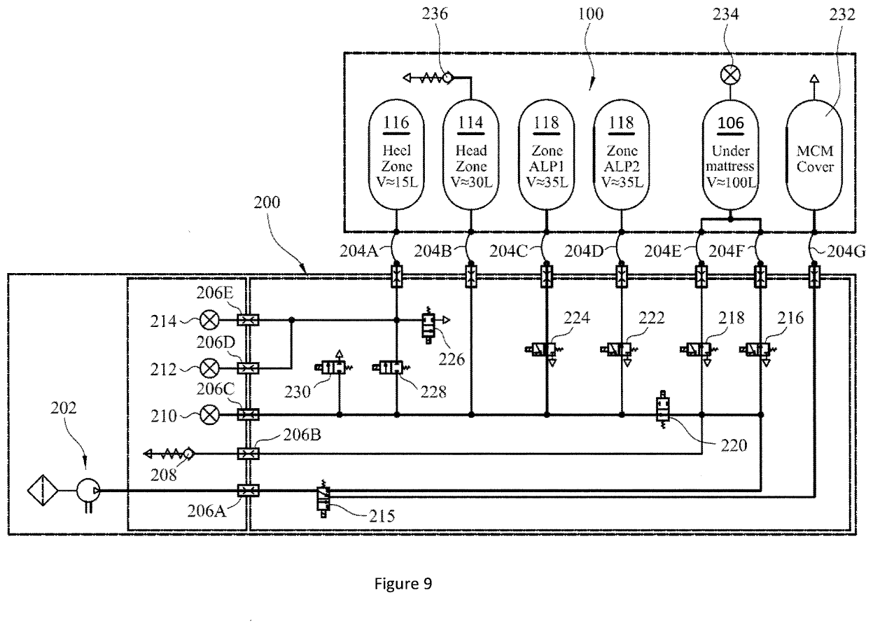

In a known manner, each of the inflatable cells of the mattress 1 is provided with a connector for connecting the cell to a fluid supply device, in the form of a pneumatic inflation and pressure regulation device (not shown). A suitable exemplary pneumatic inflation and pressure regulation device is shown in FIG. 9 and described below in connection with the mattress embodiment of FIGS. 4 to 8. The fluid supply device may be received beneath the mattress 1 in a cavity of a frame of a patient support apparatus supporting the mattress, or separate from the mattress 1 and a patient support apparatus supporting the mattress.

The air pressures within the cells of the first layer 4 in various zones of the mattress 1 may be regulated by the fluid supply device in an alternating-pressure mode, in particular as a function of the information received from a morphology sensor. Although air pressures within any of the cells of the first layer 4 may be regulated in an alternating-pressure mode, typically the cells of the shoulder zone 10, abdominal zone 12 and pelvic zone 14 are regulated in an alternating-pressure mode.

The air pressures within the cells of the second layer 6 may be regulated by the fluid supply device in a substantially constant pressure mode.

In accordance with the present disclosure, the mattress 1 further comprises a valve system comprising a plurality of valves 36. In this embodiment, the valve system comprises five valves 36, each valve being fluidly connected to one of the inflatable cells of the second layer 6. In this embodiment, each valve 36 is a manually operated T-valve having an inlet configured to be fluidly connected to a fluid supply device, a first outlet configured to be connected to the connector of an inflatable cell of the mattress 1, and a second outlet configured as an exhaust. Each valve 36 also comprises an actuator that is manually controllable by a caregiver to selectively direct fluid from the inlet to either of the first outlet, for inflating the cell of the mattress, and the exhaust, for deflating the cell of the mattress.

It will be appreciated that the valves 36 of the valve system need not be manually operated valves, but may be controllable by a controller, such as a controller of a fluid supply device. In other embodiments, the valves 36 may be solenoid valves controllable by a controller.

Accordingly, in this embodiment the valve system of the mattress enables individual cells of the second layer 6 to be deflated by actuating the valve 36 of the cell to direct fluid from the inlet to the exhaust. Since each cell of the second layer 6 extends across a zone of the mattress 1, the valve system of the mattress provides a caregiver with straightforward control over the inflation and deflation of each one of the zones of the second layer 6 of the mattress 1.

A caregiver may wish to deflate a zone of the second layer 6 of the mattress 1 in order to reduce the interface pressure between a patient supported on the mattress and the mattress at a specific location. In particular, deflation of one or more zones of the second layer may be desirable when a patient is supported on the mattress in the prone position.

In the first layer 4 of the mattress 1, all adjacent inflatable cells are secured together in some manner, apart from the adjacent end cells of the head zone 8 and the shoulder zone 10. Accordingly, if the cell 30 of the second layer 6 in the abdominal zone 12 is deflated, the cells of the first layer 4 in the abdominal zone 12 are supported at both ends by the cells of the first layer 4 in the shoulder zone 10 and the cells of the first layer 4 in the pelvic zone 14. Similarly, if the cell 32 of the second layer 6 in the pelvic zone 14 is deflated, the cells of the first layer 4 in the pelvic zone 14 are supported at both ends by the cells of the first layer 4 in the abdominal zone 12 and the cells of the first layer 4 in the leg zone 16.

FIGS. 2 and 3 show the mattress 1 configured to support a patient in the prone position. As shown in FIGS. 2 and 3, the cell 26 of the second layer 6 in the head zone 8 has been deflated by adjusting the valve 36 of the cell 26 to exhaust to atmosphere. The cells of the first layer 4 in the head zone 8 have also been deflated to create a large depression at the head zone 8 of the mattress 1, such that a head support element 38 may be positioned on the support surface 2 in the depression in the head zone 8 for appropriately supporting the head of the patient.

Also as shown in FIGS. 2 and 3, the cell 30 of the second layer 6 in the abdominal zone 12 has been deflated. The cells 18 of the first layer 4 in the abdominal zone 12 have not been deflated, and are supported at both ends by the cells 18 of the first layer 4 in the shoulder zone 10 and the cells 20 of the first layer 4 in the pelvic zone 14 in the manner of a hammock. The “hammocked” cells 18 of the first layer 4 in the abdominal zone 12 provide support to the abdomen of a patient on the mattress, but at a lower or reduced pressure than if the cell 30 of the second layer 6 in the abdominal zone 12 had been inflated. This reduced pressure in the abdominal zone 12 may lower the risk of the patient developing pressure injuries in the abdominal zone, without significantly increasing the pressure between the patient and the mattress at the shoulder zone 10 and the pelvic zone 14.

FIG. 4 shows a schematic illustration of a multiway valve 110 of a valve system of a mattress according to a second embodiment of the present disclosure.

The multiway valve 110 comprises an inlet (not shown) configured to be fluidly connected to a fluid supply device, a first outlet 112 (outlet A) configured to be connected to a connector of an inflatable cell of a mattress, a second outlet 114 (outlet B) configured to be connected to a connector of an inflatable cell of a mattress, a third outlet 116 (outlet C) configured as an exhaust, and a fourth outlet 118 (outlet D) configured to be connected to a connector of an inflatable cell of a mattress.

The multiway valve 110 further comprises an actuator that is manually controllable by a caregiver to selectively direct fluid from the inlet to one of the first outlet 112, the second outlet 114, the third outlet 116 and the fourth outlet 118.

It will be appreciated that the multiway valve 110 need not be a manually operated valve, but may be a valve that is controllable by a controller, such as a controller of a fluid supply device. In some embodiments, the multiway valve 110 may be solenoid valve that is controllable by a controller.

FIGS. 5-8 show schematic illustrations of a mattress 100 according to a second embodiment of the present disclosure.

The mattress 100 comprises a support surface 101 for supporting a body of a patient. The mattress 100 further comprises a plurality of inflatable cells arranged below the support surface 101 and contained in a removable cover 102. The plurality of inflatable cells are arranged in layers comprising: a first layer 104 of inflatable cells 105 arranged directly below the support surface 101; a second layer 106 of inflatable cells 107 arranged directly below the first layer 104; and a third layer 108 comprising one inflatable cell 109. Each inflatable cell 105 of the first layer 4 is arranged above at least one inflatable cell 107 of the second layer 6, and each inflatable cell 107 of the second layer 106 is arranged above the inflatable cell 109 of the third layer.

The support surface 101 is generally rectangular and has a length and a width. The first layer 104 extends the entire length and width of the support surface 101, such that an upper surface of the first layer 104 substantially forms the support surface 101. The second layer 106 also extends the entire length and width of the support surface 101, such that each inflatable cell of the first layer 104 is supported over the entire length and width of the cell by at least one cell of the second layer 106. The third layer 108 also extends the entire length and width of the support surface 101, such that each inflatable cell of the second layer 106 is supported over the entire length and width of the cell by at least one cell of the third layer 108.

The mattress 100 is divided along its length into a plurality of zones. In this embodiment, the mattress is divided into three zones as follows: a first zone 120 for supporting the torso and the head of a patient supported on the mattress; a second zone 122 for supporting the legs and the feet of a patient supported on the mattress; and a third zone 124 interposed between the zones 120 and 122 and for supporting the pelvis of a patient supported on the mattress.

The first layer 104 is formed by juxtaposing inflatable cells 105 that are generally in the form of sausage-shaped tubes extending in the direction of the width of the mattress. The cells 105 of the first layer 104 are generally disposed side-by-side in a row in the direction of the length of the mattress. All of the cells 105 of the first layer 104 are substantially identical, each having a circular cross-section when the cell is inflated. In this embodiment, the inflatable cells 105 of the first layer 104 are formed by flat butt welding (e.g., heat-sealing) together two sheets of polyurethane, along weld lines that are mutually parallel.

The second layer 106 is substantially identical to the first layer 104. Accordingly, the second layer 106 is formed by juxtaposing inflatable cells 107 that are generally in the form of sausage-shaped tubes extending in the direction of the width of the mattress. The cells 107 of the second layer 106 are generally disposed side-by-side in a row in the direction of the length of the mattress. All of the cells 107 of the second layer 106 are substantially identical, each having a circular cross-section when the cell is inflated. In this embodiment, the inflatable cells 107 of the second layer 106 are formed by flat butt welding (e.g., heat-sealing) together two sheets of polyurethane, along weld lines that are mutually parallel.

The number of inflatable cells 105 of the first layer 104 is the same as the number of inflatable cells 107 of the second layer 106, and the first layer 104 is substantially aligned with the second layer 106 such that each inflatable cell 105 of the first layer 104 is arranged above a corresponding inflatable cell 107 of the second layer 106.

The third layer 108 comprises a single inflatable cell 109. The single inflatable cell 109 of the third layer 108 extends substantially the length and the width of the mattress, such that all of the inflatable cells 107 of the second layer 106 are arranged above the inflatable cell 109 of the third layer 108.

The first layer 104 and the third layer 108 are releasably secured to the cover 102 by plastic press studs (not shown). The second layer 106 is releasably secured to the underside of the first layer 104 by plastic press studs (not shown) and releasably secured to the top side of the third layer 108 by plastic press studs (not shown).

In accordance with the present disclosure, the mattress 100 further comprises a valve system comprising a plurality of multiway valves 110.

In this embodiment, the valve system comprises one multiway valve 110 for each of the inflatable cells 105 of the first layer 104. Outlet A of each multiway valve 110 is fluidly connected to one of the inflatable cells 105 of the first layer 104. Outlet B of each multiway valve 110, apart from the multiway valve 110 having outlet A fluidly connected to the end inflatable cell at the foot end of the mattress 100, is fluidly connected to a first inflatable cell 107 of the second layer 106. The first inflatable cell 107 of the second layer 106 is adjacent, in the direction of the foot end of the mattress 100, to the cell 107 of the second layer 106 that is directly below the inflatable cell 105 of the first layer 104 that is fluidly connected to outlet A of the multiway valve 110. Outlet C of each multiway valve is configured as an exhaust. Outlet D of each multiway valve 110, apart from the multiway valve 110 having outlet A fluidly connected to the end inflatable cell 105 of the first layer 104 at the head end of the mattress 100, is fluidly connected to a second inflatable cell 107 of the second layer 106. The second inflatable cell 107 of the second layer 106 is adjacent, in the direction of the head end of the mattress 100, to the cell 107 of the second layer 106 that is directly below the inflatable cell 105 of the first layer 104 that is fluidly connected outlet A of the multiway valve 110.

Put in another way, Outlets B and D of each multiway valve 110 are fluidly connected to the inflatable cells 107 of the second layer 106 at opposite sides of the inflatable cell 107 of the second layer 106 arranged directly below the inflatable cell 105 of the first layer 106 that is fluidly connected to outlet A of the multiway valve 110. This arrangement of the multiway valves 110, and the effects of the arrangement, are shown in FIGS. 6, 7 and 8.

In a known manner, each of the inflatable cells of the mattress 100 is provided with a connector for connecting the cell to a fluid supply device, in the form of a pneumatic inflation and pressure regulation device (not shown). A suitable exemplary pneumatic inflation and pressure regulation device is shown in FIG. 9. The fluid supply device may be received beneath the mattress 100 in a cavity of a frame of a patient support apparatus supporting the mattress, or separate from the mattress 100 and a patient support apparatus supporting the mattress.

In this embodiment, the multiway valves 110 are arranged between the connectors of the cells 105, 107 of the first and second layers 104, 106 and the fluid supply device. As such, the only supply of air provided to the inflatable cells 105, 107 of the first and second layers 104, 106 is provided through the inlets of the multiway valves 110.

The air pressures within the inflatable cells 105, 107 of the first and second layers 104, 106 may be regulated by the fluid supply device in an alternating-pressure mode, in particular as a function of the information received from a morphology sensor. The air pressure within the inflatable cell 109 of the third layer 108 may be regulated by the fluid supply device in a substantially constant pressure mode.

By default, all of the multiway valves 110 may be arranged to direct fluid from the inlet to outlet A. In this default position, air from a fluid supply device is directed into the inflatable cells 105 of the first layer 104, inflating the cells 105 of the first layer 104, and no air is directed into the inflatable cells 107 of the second layer 106, maintaining the cells 107 of the second layer 106 in a deflated state. This configuration is shown in FIG. 5. This default configuration may be appropriate to support a patient in a supine position.

An exemplary adjusted configuration of the multiway valves 110 is shown in FIG. 6.

A first inflatable cell 130 of the first layer 104, in the first zone 120, is fluidly connected to outlet A of a first multiway valve 131. The first inflatable cell 130 of the first layer 104 is arranged above a first inflatable cell 132 of the second layer 106.

A second inflatable cell 134 of the first layer 104, located in the second zone 124 away from the first inflatable cell 130, is fluidly connected to an outlet A of a second multiway valve 135. The second inflatable cell 134 of the first layer is arranged above a second inflatable cell 136 of the second layer 106.

A third inflatable cell 138 of the first layer 104 is fluidly connected to an outlet A of a third multiway valve 139. The third inflatable cell 138 of the first layer 104 is arranged above a third inflatable cell 140 of the second layer 106. The third inflatable cells 138, 140 of the first and second layers 104, 106 are adjacent to the second inflatable cells 134, 136 of the first and second layers 104, 106 in the direction of the foot end of the mattress.

A fourth inflatable cell 142 of the first layer 104 is fluidly connected to an outlet A of a fourth multiway valve 143. The fourth inflatable cell 142 of the first layer 104 is arranged above a fourth inflatable cell 144 of the second layer 106. The fourth inflatable cells 142, 144 of the first and second layers 104, 106 are adjacent to the third inflatable cells 138, 140 of the first and second layers 104, 106 in the direction of the foot end of the mattress.

A fifth inflatable cell 146 of the first layer 104 is fluidly connected to an outlet A of a fifth multiway valve 147. The fifth inflatable cell 146 of the first layer 104 is arranged above a fifth inflatable cell 148 of the second layer 106. The fifth inflatable cells 146, 148 of the first and second layers 104, 106 are adjacent to the fourth inflatable cells 142, 144 of the first and second layers 104, 106 in the direction of the foot end of the mattress.

Outlet B of the second multiway valve 135 is fluidly connected to the third inflatable cell 140 of the second layer 106.

Outlet B of the third multiway valve 139 is fluidly connected to the fourth inflatable cell 144 of the second layer 106 and outlet D of the third multiway valve is fluidly connected to the second inflatable cell 136 of the second layer 106.

Outlet B of the fourth multiway valve 143 is fluidly connected to the fifth inflatable cell 148 of the second layer 106 and outlet D of the fourth multiway valve is fluidly connected to the third inflatable cell 140 of the second layer 106.

Outlet D of the fifth multiway valve 147 is fluidly connected to the fourth inflatable cell 144 of the second layer 106.

As shown in FIG. 6, the first multiway valve 131 has been adjusted to direct fluid from the inlet to outlet C. Since outlet C is configured as an exhaust, air from the inlet is directed out of the exhaust to atmosphere. Since air from the inlet is not directed to the first inflatable cell 130 of the first layer 104, via outlet A, the first inflatable cell 130 is deflated. Accordingly, adjusting a multiway valve to direct fluid from the inlet to outlet C results in deflation of the inflatable cell of the first layer fluidly connected to outlet A. The first inflatable cell 132 of the second layer 106 has not been affected by adjustment of the first multiway valve 131, and remains deflated. This type of adjustment of a multiway valve may be used to provide clearance from the mattress for a portion of the patient at risk of developing a pressure ulcer. The depth of clearance provided by this adjustment is, at most, the depth of the inflated cells 105 of the first layer 104.

Also as shown in FIG. 6, the third multiway valve 139 has been adjusted to direct fluid from the inlet to outlet D, and the fourth multiway valve 143 has been adjusted to direct fluid from the inlet to outlet B.

In this position of the third multiway valve 139, fluid is directed by the third multiway valve 139 from the inlet to the second cell 136 of the second layer 106, rather than the third cell 138 of the first layer 104. Accordingly, the third cell 138 of the first layer 104 is deflated and the second cell 136 of the second layer 106 is inflated. The second cell 136 of the second layer 106 pushes up on the second cell 134 of the first layer 104 arranged above it. As such, the second cell 134 of the first layer 134 raises an area of the support surface 101, in a similar manner to arranging a separate support element on the support surface 101.

Similarly, in this position of the fourth multiway valve 143 fluid is directed by the fourth multiway valve 143 from the inlet to the fifth cell 148 of the second layer 106, rather than the fourth cell 142 of the first layer 104. Accordingly, the fourth cell 142 of the first layer 104 is deflated and the fifth cell 148 of the second layer 106 is inflated. The fifth cell 148 of the second layer 106 pushes up on the second cell 146 of the first layer 104 arranged above it to form a raised area of the support surface 101.

These types of adjustment of a multiway valve may be used to provide clearance from the mattress for a portion of the patient and to provide additional support to an adjacent area of the patient. The depth of clearance between the adjacent inflated and deflated pairs of cells provided by this type of adjustment is, at most, the depth of an inflated cell 105 of the first layer 104 and the depth of an inflated cell 107 of the second layer 106.

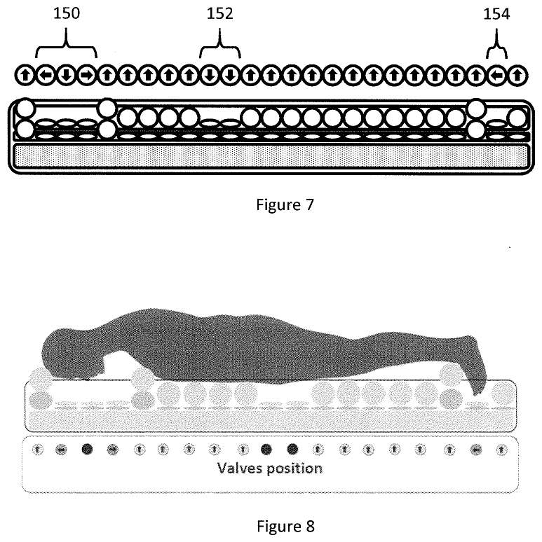

FIGS. 7 and 8 show the mattress 100 with the multiway valves 110 of the valve system adjusted to configure the inflatable cells of the mattress to appropriately support a patient in the prone position. A caregiver has selected the appropriate multiway valves to adjust in order to appropriately support the particular patient supported on the mattress 100.

In the first zone 120, three multiway valves 150 have been adjusted to deflate the three consecutive cells of the first layer 104 and to inflate the cells of the second layer 106 adjacent to the deflated cells at both ends. The valve 150 closest to the head end of the mattress has been adjusted to direct fluid from the inlet to outlet D, the middle one of the valves 150 has been adjusted to direct fluid from the inlet to outlet C, and the valve 150 closest to the foot end of the mattress has been adjusted to direct fluid from the inlet to outlet B. The three consecutive deflated cells of the first layer 104 form a depression in the mattress for receiving the face of the patient. The inflated cell of the second layer 106 adjacent to the depression, towards the head end of the mattress, pushes up on the cell of the first layer 104 above it to form a raised area of the mattress for supporting the top of the head of the patient. The inflated cell of the second layer 106 adjacent to the depression, towards the foot end of the mattress, pushes up on the cell of the first layer 104 above it to form a raised area of the mattress for supporting the shoulders and top of the chest of the patient.

In the central zone 124, two multiway valves 152 have been adjusted to deflate two consecutive cells of the first layer 104. Both valves 152 have been adjusted to direct fluid from the inlet to the outlet C. The two consecutive deflated cells of the first layer 104 form a depression in the mattress for receiving the pelvis of the patient. Raised areas either side of the depression are not required to provide additional support to the patient in this area, and so are not provided.

In the heel zone 122, one multiway valve 154 has been adjusted to deflate one cell of the first layer 104 and to inflate an adjacent cell of the second layer 106, towards the head end of the mattress. The multiway valve 154 has been adjusted to direct fluid from the inlet to the outlet D. The deflated cell of the first layer 104 forms a depression in the mattress for receiving the feet of the patient. The inflated cell of the second layer 104 adjacent to the depression in the direction of the head end of the mattress provides additional support to the ankles of the patient.

A manifold 200 and pneumatic inflation and pressure regulation device 202 suitable for use with the mattress 100 are shown in FIG. 9. The manifold 200 and pneumatic inflation and pressure regulation device 202 are based on FIG. 2 from European patent application publication number EP 3228294 A1. It will be appreciated that other fluid supply devices may also be suitable to be coupled to the mattress 100 to regulate inflation and deflation of the inflatable cells of the mattress.

As shown in FIG. 9, the mattress 100 is pneumatically coupled to a fluid supply device in the form of a manifold 200 and pneumatic inflation and pressure regulation device 202.

The manifold 200 comprises a plurality of coupling ports 204A, 204B, 204C, 204D, 204E, 204F and 204G for pneumatically coupling each of the layers and zones of the mattress 100 to the manifold 200. The manifold 200 further comprises a plurality of coupling ports 206A, 206B, 206C, 206D and 206E for pneumatically coupling the manifold to the pneumatic inflation and pressure regulation device 202, a pressure relief valve 208, equipment used by a technician during maintenance 210 and 212, and a pressure sensor 214 respectively. The manifold also comprises a plurality of solenoid valves 215, 216, 218, 220, 222, 224, 226, 228, and 230 for selectively isolating various components of the mattress 100 from each other and/or from the pneumatic inflation and pressure regulation device 202. Each solenoid valve is configured to enable exhaust to atmosphere.

The solenoid valve 215 is configured to isolate the mattress 100 from the pneumatic inflation and pressure regulation device, and to couple the pneumatic inflation and pressure regulation device to a micro-climate management (MCM) cover 232, which is not shown in FIG. 9. The MCM cover 232 may be provided on top of the mattress 100 to regulate the temperature and moisture adjacent the person being supported by the mattress 100.

The solenoid valve 220 is configured to isolate the third layer 108. Solenoid valves 216 and 218 enable the third layer 108 to be exhausted to atmosphere. The third layer 108 may be exhausted to atmosphere because a leak has been detected in that layer.

The solenoid valves 222 and 224 are configured to isolate and/or exhaust to atmosphere the central zone 124 of the therapeutic first and second layers 104, 106. This enables the zone to be exhausted in the event of a leak.

The solenoid valve 226 enables the heel zone 122 of the therapeutic first and second layers 104, 106 to be exhausted to atmosphere in the event a leak is detected.

The solenoid valve 228 enables the heel zone 122 of the therapeutic first and second layers 104, 106 to be isolated from the pneumatic inflation and pressure regulation device, and from other portions of the mattress 100.

The solenoid valve 230 enables some or all of the inflatable cells of the mattress 100 to be exhausted to atmosphere in dependence on the configuration of the other of the solenoid valves. This can enable the zones to be exhausted in the event of a leak or for generally exhausting the mattress.

As can also be seen from FIG. 9, the third layer 108 is provided with a pressure sensor 234 for determining the air pressure therein. A pressure relief valve 236 is pneumatically coupled to the head zone 20 of the therapeutic first and second layers 104, 106 to prevent the therapeutic first and second layers 104, 106 from being over-inflated, which may cause damage. The pressure relief valve 208 prevents the third layer 108 from being over-inflated, which also may cause damage.

In use, the manifold 200 and pneumatic inflation and pressure regulation device 202 are configured to pressurize the first, second and third layers 104, 106, 108 as desired, and as described above. In addition to the standard control method, the controller may also be configured to monitor whether the first, second and third layers 104, 106, 108 develop an air leak.

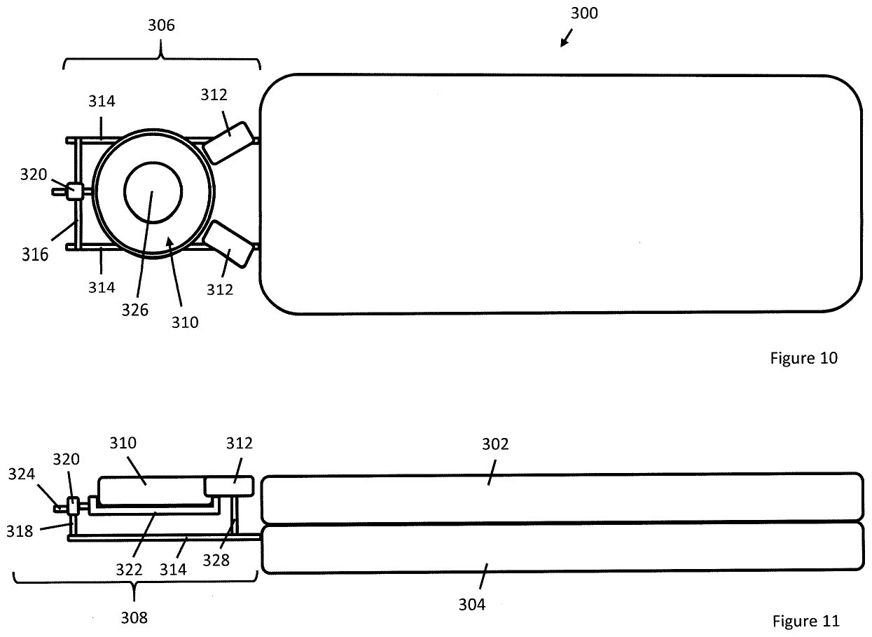

FIGS. 10 and 11 show schematic illustrations of a patient support apparatus 300 according to a third embodiment of the present disclosure.

The patient support apparatus comprises a mattress 302 supported on a patient support apparatus frame 304 and also comprises a head support 306 supported on the patient support apparatus frame 304 at a head end of the patient support apparatus 300. The head support 306 is configured to provide support for the head of a patient when the body of the patient is supported on the mattress 302 and the head of the patient is positioned off the mattress 302, beyond the head end of the mattress 302.

The head support 306 comprises a head support frame 308, a headrest 310 and a pair of shoulder rests 312. The head support frame 308 extends from the head end of the patient support apparatus frame 304, beyond the head end of the mattress 302. A proximal end of the head support frame 308 is removably secured to the patient support apparatus frame 304, such that the head support 306 may be removed from the patient support apparatus frame 304 when it is not required.

In this embodiment, the head support frame 308 comprises a pair of arms 314 extending from the head end of the patient support apparatus frame 304, spaced apart by a distance slightly less than the width of the mattress. In this embodiment, the patient support apparatus frame 304 is provided with clamps (not shown) for removably securing a proximal end of the arms 314 to the patient support apparatus frame 304.

The head support frame 308 further comprises a crossbar 316 extending between the pair of arms 314 at a distal end, opposite the proximal end of the arms. The crossbar 316 is slidably mounted to the arms 314 on lockable clamps (not shown), such that the crossbar 316 is slidable along the arms 314 in the direction of the length of the patient support apparatus 300. A pillar 318 is slidably mounted to the crossbar 316 on a lockable clamp (not shown), such that the pillar 318 may be moved along the crossbar 316 in the direction of the width of the patient support apparatus 300, and locked in position at a desired location. A lockable ball-joint 320 is slidably mounted on the pillar 318 and movably supports a headrest support 322. The lockable ball-joint 320 is slidable along the pillar 318 in the direction of the height of the patient support apparatus 300 and the headrest support 322 is rotatable in two planes about the ball-joint 320 to vary the orientation of the headrest support 322. The lockable ball-joint 320 comprises handles 324 for locking and unlocking the position of the joint 320 on the pillar 318 and for locking and unlocking the orientation of the headrest support 322 relative to the ball-joint 320.

The headrest 310 generally comprises a pillow of viscoelastic foam for comfortably supporting the head of a patient. In this embodiment, the headrest 310 has a general cylindrical shape, with a cylindrical central passage 326, open at both ends, through which ventilation tubes may be passed to the mouth and nose of a patient supported on the patient support apparatus 300 in the prone position. Accordingly, the headrest 310 has a substantially annular shape.

The headrest support 322 generally comprises a platform or tray for supporting the headrest 310, and in this embodiment comprises a cavity configured to receive the headrest 310. The headrest support 322 also comprises a central passage (not shown), open at both ends, in the cavity that is alignable with the central passage of the headrest 310 to enable ventilation tubes to pass through the headrest support 322 to a patient.

In this embodiment, the head support frame 308 movably supports the headrest 310 such that the position and orientation of the headrest 310 is fully adjustable relative to the mattress 302. This may enable the head support 306 to be adjusted to appropriately support the heads of patients of different sizes.

The head support frame 308 further comprises a pair of pillars 328, each pillar 328 being slidably mounted on an arm 314 of the frame 308, between the crossbar 316 and the proximal end of the arm 314, on a lockable clamp (not shown). Accordingly, the pillars 328 are slidable along the arms 314 in the direction of the length of the patient support apparatus 300 and are lockable in the position. Each pillar 328 supports one of the pair of shoulder rests 312 at a distal end of the pillar, opposite the lockable clamp. In this embodiment, the pillars 328 are telescopic, which further enables the height of the shoulder rests 312 to be adjusted. Accordingly, the position of the shoulder rests 312 is adjustable to appropriately support the shoulders of patients of different sizes.

Each shoulder rest 312 generally comprises a pillow of the same viscoelastic foam as headrest 310, and is substantially stadium shaped for supporting a shoulder of a patient.

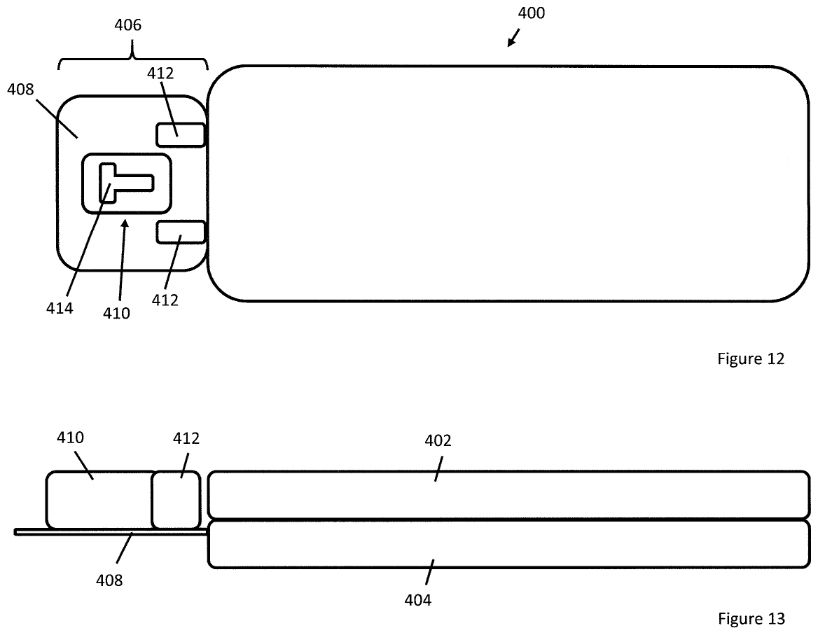

FIGS. 12 and 13 show schematic illustrations of a patient support apparatus 400 according to a fourth embodiment of the present disclosure.

The patient support apparatus 400 is substantially similar to the patient support apparatus 300 described above with reference to FIGS. 10 and 11. The patient support apparatus 400 comprises a mattress 402 supported on a patient support apparatus frame 404 and also comprises a head support 406 supported on the patient support apparatus frame 404 at a head end of the patient support apparatus 400.

In this embodiments, the head support 406 comprises a head support frame 408, a headrest 310 and shoulder rests 412. The head support frame 408 extends from the head end of the patient support apparatus frame 404, beyond the head end of the mattress 402. A proximal end of the head support frame 408 is slidably secured to the patient support apparatus frame 304, such that the head support frame 408 may be moved between an extended position, when the head support 406 is required, and a retracted position, when the head support 406 is not required.

In this embodiment, the head support frame 408 comprises a platform for supporting the headrest 410 and shoulder rests 412. The platform 408 is generally planar and is slidably supported by the patient support apparatus frame 404 on rails (not shown). The platform 408 is slidable relative to the patient support apparatus frame 404 between the extended position, as shown in FIGS. 12 and 13, and the retracted position, in which the platform 408 is stowed in a space in the patient support apparatus frame 404 beneath the mattress 402. The platform 408 may be lockable in both the extended position and the retracted position, if desired.

The headrest 410 generally comprises a polymer gel block for comfortably supporting the head of a patient. In this embodiment, the headrest 410 generally has a cubic shape with a t-shaped passage 414, open at both ends, through which ventilation tubes may be passed to the mouth and nose of a patient supported on the patient support apparatus 400 in the prone position. The T-shaped passage 414 may enable the eyes, nose and mouth of a patient supported on the patient support apparatus 400 in the prone position to be remain clear of the headrest 410, while also providing support most other areas of the face of the patient.

The pair of shoulder rests 412 generally comprise stadium shaped polymer gel blocks for comfortably supporting the shoulders of a patient.

The headrest 410 and pair of shoulder rests 412 may be removably positioned on the platform 408 in any desired position for appropriately supporting the head and shoulders of a patient respectively. The weight of the rests 410, 412 and the weight of a patient supported on the rests is sufficient to maintain the rests 410, 412 in the desired position on the platform 408.

In this embodiment, the position of the rests 410, 412 on the platform 408 and the size of the rests 410, 412 may be selected by a caregiver to appropriately support the heads and shoulders of patients of different sizes.

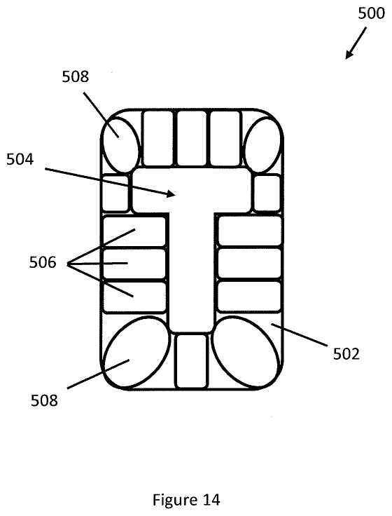

FIG. 14 shows a schematic illustration of a pneumatic headrest 500 suitable for use with the head supports of the patient support apparatus 300, 400 of the third and fourth embodiments of the present disclosure.

The headrest 500 comprises a generally rectangular platform 502 having a T-shaped passage 504, open at both ends, extending through the center of the platform. A plurality of inflatable cells are arranged on one side of the platform, around the T-shaped passage 504. Each one of the plurality of inflatable cells comprises a connector for connecting to a fluid supply device for inflating the cell. The fluid supply device may be same fluid supply device provided for supplying fluid to the mattress of the patient support apparatus.

When the inflatable cells of the headrest 500 are inflated, the headrest 500 forms a cushion substantially similar to the headrest 410 described above in relation to FIGS. 12 and 13. Accordingly, the inflatable cells of the headrest 500 are shaped and arranged in a manner to appropriately support the head of a patient in the prone position, with the T-shaped passage remaining clear to provide clearance from the eyes, nose and mouth of the patient. An exemplary arrangement of inflatable cells is shown in FIG. 15, with substantially rectangular shaped cells 506 being provided along the sides of the platform 502 and passage 504, and substantially oval shaped cells 508 being provided at corners.

Inflation and deflation of the inflatable cells of the headrest 500 may be regulated in any suitable manner. In some contemplated embodiments, the inflatable cells of the headrest 500 may be inflated and deflated in accordance with an alternating-pressure mode, as described above in relation to the first and second layers of a mattress.

It will be appreciated that other shapes of headrest and arrangements of inflatable cells may be provided. It will also be provided that adjacent inflatable cells of the headrest may be secured together. Where adjacent inflatable cells of the headrest are secured together, it may not be necessary to provide the inflatable cells on a platform, provided that the inflatable cells are secured together in such a way as to maintain a desired geometric shape.

It will be appreciated that the above described embodiments are only exemplary embodiments according to the present disclosure. It will also be appreciated that features described above in relation to one embodiment of the disclosure may also be applied to other embodiments of the disclosure.

1. A mattress comprising:
a support surface for supporting the body of a patient;
a plurality of inflatable cells arranged below the support surface, the plurality of inflatable cells being arranged in layers comprising:
a first layer of inflatable cells arranged below the support surface; and
a second layer of inflatable cells arranged below the first layer, wherein each inflatable cell of the first layer is arranged above at least one cell of the second layer; and
a valve system comprising a plurality of valves, each valve being fluidly connected to an inflatable cell of the second layer of the plurality of inflatable cells and each valve being controllable to enable inflation and deflation of the inflatable cell such that the inflatable cells of the second layer are selectively deflatable on actuating the valves of the valve system,
wherein the mattress comprises a prone therapy region comprising at least a portion of the first layer of inflatable cells and a portion of the second layer of inflatable cells, the portion of the second layer being below the portion of the first layer, wherein one or more of the valves of the valve system is fluidly connected to an inflatable cell of the second layer in the prone therapy region, and wherein adjacent cells of the first layer in the prone therapy region are held together.

2. The mattress of claim 1, wherein in the prone therapy region each inflatable cell of the first layer of inflatable cells is fluidly connected to a valve of the valve system, such that the valve system is configured to selectively enable inflation and deflation of each of the inflatable cells of the first layer individually.

3. The mattress of claim 1, wherein adjacent cells of the first layer in the prone therapy region are bonded together.

4. The mattress of claim 1, wherein the valve system comprises one or more multiway valves, each multiway valve being fluidly connected to an inflatable cell of the first layer in the prone therapy region, and each multiway valve comprising:
an inlet connectable to a fluid supply device; and
a plurality of outlets, one of the outlets being connected to the inflatable cell of the first layer, one of the outlets being connected to a first one of the cells of the second layer, one of the outlets being connected to an exhaust, and one of the outlets being connected to a second one of the cells of the second layer,
wherein each multiway valve is configured to selectively direct fluid from the inlet to one of the plurality of outlets.

5. The mattress of claim 4, wherein in the prone therapy region:
the first and second layers of inflatable cells comprise the same number of inflatable cells;
each inflatable cell of the second layer is arranged below a corresponding inflatable cell of the first layer;
the valve system comprises a plurality of the multiway valves; and
each inflatable cell of the first layer is fluidly connected to one of the multiway valves of the valve system, such that the valve system is configured to selectively enable inflation and deflation of each of the inflatable cells of the first layer individually.

6. The mattress of claim 5, wherein in the prone therapy region each multiway valve is arranged such that the first and second ones of the inflatable cells of the second layer that are fluidly connected to outlets of the multiway valve are arranged on opposite sides of the inflatable cell of the second layer that is arranged below the inflatable cell of the first layer that is fluidly connected to an outlet of the multiway valve.

7. The mattress of claim 1, wherein:
the mattress has a length extending from a head end to a foot end;
the first layer of inflatable cells are arranged side-by-side in a row along the length of the mattress from the head end to the foot end; and
the second layer of inflatable cells are arranged side-by-side in a row along the length of the mattress from the head end to the foot end.

8. The mattress of claim 1, wherein at least one of:
the inflatable cells of the second layer extend substantially in the direction of the width of the mattress; and
the inflatable cells of the first layer extend substantially in the direction of the width of the mattress.

9. The mattress of claim 1, wherein:
the mattress has a length and the mattress is divided along its length into at least four zones; and
the second layer of inflatable cells comprises at least four inflatable cells, the second layer comprising at least one inflatable cell in each zone of the mattress.

10. The mattress of claim 9, wherein adjacent inflatable cells of the first layer are secured together.

11. The mattress of claim 1, wherein the plurality of inflatable cells further comprise a third layer comprising at least one inflatable cell, wherein each inflatable cell of the second layer is arranged above at least one inflatable cell of the third layer.

12. A mattress system comprising:
the mattress as claimed in claim 1; and
a fluid supply device comprising:
a compressor fluidly connectable to the plurality of inflatable cells and operable to supply fluid to the plurality of inflatable cells to inflate the cells; and
a controller configured to control the supply of fluid to the inflatable cells to control inflation and deflation of the cells.

13. The mattress system of claim 12, wherein the fluid supply device comprises one or more fluid supply conduits, each fluid supply conduit comprising an inlet for connection to the compressor and a plurality of outlets, each inflatable cell being fluidly connected to a fluid supply conduit of the fluid supply device.

14. The mattress system of claim 12, wherein:
the controller is configured to supply fluid to the first layer of inflatable cells in one of a continuous pressure mode, in which the cells of the first layer are inflated at a substantially continuous pressure, and an alternating-pressure mode, in which cells of the first layer are inflated and deflated simultaneously, and in alternation;
the controller is configured to supply fluid to the second layer of inflatable cells in a continuous pressure mode, in which the cells of the first layer are inflated at a substantially continuous pressure;
adjacent cells of the first layer are held together; and
the inflatable cells of the second layer are selectively deflatable on actuating the valves of the valve system.
